(19) United States
(12) Patent Application Publication
(10) Pub. No.: US 2005/0102526 A1
(43) Pub. Date: May 12, 2005

(54) System governing the sending and delivery of electronic mail using an eMstamp

(76) Inventors: Melville G. Davey, Swansea, MA (US); Melville G. Davey III, Niantic, CT (US)

Correspondence Address: Melville G. Davey, P.O. Box 212, Swansea, MA, 02777, US

(21) Appl. No.: 10/704,304

(22) Filed: Nov. 10, 2003

(51) Int. Cl. H04L 9/32

(52) U.S. Cl. 713/188

(57) ABSTRACT

A system and method for governing the sending and receiving of electronic mail, especially unsolicited bulk mail, spam, and mail viruses is described. A data token called an eMstamp, having a monetary value related to a number of imbedded eMstamp credits, is made a part of an outgoing electronic mail message transaction by the outgoing mail server. A mail server receiving mail examines the data of a message related eMstamp and makes rule based decisions to deliver or reject a mail message to the intended recipient mailbox based on the eMstamp data. Mail servers retain counts of incoming and outgoing eMstamp credits and use incoming eMstamp credits to offset credits needed to send mail. Administrators of mail servers having a greater number of outgoing eMstamp credits over incoming credits, will need to purchase eMstamp credits from an issuing agent to facilitate message delivery to other eMstamp enabled mail servers. Administrators of mail servers having a greater number of incoming eMstamp credits over outgoing credits can periodically redeem the excess of eMstamp credits for a monetary amount related to the purchase cost of credits. An intended consequence of the invention is to transfer revenue derived from the sale of eMstamp credits to eMstamp mail servers receiving more mail than is sent and to discourage the indiscriminate sending of electronic mail and self replicating e-mail viruses.

### FIELD OF INVENTION

The present invention relates to a system and method for governing the delivery of electronic mail messages over a communications network such as the Internet.

### COPYRIGHT NOTICE

A portion of the disclosure of this patent document contains material that is subject to copyright protection. The copyright owner has no objection to the. facsimile reproduction by anyone of the patent document or the patent disclosure as it appears in the Patent and Trademark Office patent file or records, but otherwise reserves all copyright rights whatsoever.

### BACKGROUND OF INVENTION

Electronic mail messaging is ubiquitous; it's popularity due in part to speed, convenience, and low cost. The low cost of sending electronic mail messages has become the catalyst for abusing mail messaging systems with e-mail viruses and unsolicited bulk mail, commonly known as spam.

Spam is most often sent to advertise products or services and frequently used to send computer viruses and objectionable material. Because the cost of sending electronic mail is very low, bulk mailers will send millions of mail messages every day. Recipient addresses for the mails are harvested in a variety of indiscriminate ways and added to mail lists which get shared, sold, and rented by, for, and to bulk mailers without regard to subscriptions or otherwise, the wishes of recipients. The spam and virus problems have reached epidemic proportions, degrading the performance and threatening the viability of the Internet and endangering national security. In April 2003 AOL reported that they alone expect to be blocking over two billion unsolicited bulk mail messages per day. Spam e-mail is currently estimated to account for over 50% of all Internet e-mail traffic.

With current electronic mail processes, the major cost of providing mail service falls to the ISP (Internet Service Provider), which receives mail for intended recipients. The ISP maintains the computer and infrastructure on which resides a mail server application for outgoing and incoming mail transactions and for maintaining mailboxes and delivering to these mailboxes, messages for intended recipients. Large amounts of monies have been spent by ISPs creating and installing application software to block or at best reduce the influx of spam mail.

However, that software frequently falls short of the intended purpose because it relies on a variety of filtering, blocking, and identification techniques to distinguish between spam and legitimate mail. McCormick, et al, in U.S. Pat. No. 6,023,723, Feb. 8, 2000 describes filtering mechanisms based on keywords and key phrases. Paul, in U.S. Pat. No. 5,999,932, Dec. 7, 1999 describes heuristic processing to filter received mail. Spammers are quick to catch on to the latest filtering techniques and modify their outgoing mail to defeat these methods.

Blocking techniques rely on identifying the sending mail server and maintaining large databases listing undesirable servers. One such blocking technique is described by Paul in U.S. Pat. No. 6,052,709, Apr. 18, 2000 and uses spam probe e-mail addresses planted at various Internet sites. If one of these e-mail addresses is received at an incoming mail server, the reverse path information is recorded to a database and any subsequent-mails from that address are blocked. Spammers are quick to subvert blocking methods by masking the originating server and by using previously unidentified relay servers. Frequently,.blocking prevents the delivery of legitimate mail.

Yet another method of limiting spam mail is based on methods of authenticating the sender. One such method is to auto reply to an incoming message using the reverse path information provided by the sender. The sender must respond to the auto reply or else it is concluded that the sender is not the party indicated by the reverse path and the mail is refused. In theory this method allows recipients of mail that is received to verify the sender and report the sender of spam mail to controlling authorities. This enforcement method fails in the short term, however, because spammers are highly mobile and elusive, frequently changing servers used to send the spam. Additionally, the Spammers location is usually outside the legal jurisdiction of enforcement authorities. U.S. Pat. No. 6,256,739 by Scopp, et al, Jul. 3, 2001 describes such a method.

Electronic mail viruses are distributed by the common SMTP process through message transfer agents and through the more insidious process of infecting a computer with an e-mail virus that includes an outgoing mail sending application that uses e-mail addresses from the target computer's address book for sending copies of itself directly to a recipients receiving message transfer agent for subsequent delivery to the recipient mailbox. These self-replicating viruses have seriously effected the viability of the Internet. Filtering and blocking software does little to prevent the spread of these viruses because they originate from legitimate sources. Firewalls help but are not installed on a majority of home computers. Other attempts to prevent the spread of self-replicating viruses have seriously degraded mail services. ISPs have had to throttle the amount of mail that can originate-from a sender in any one session. All of the above attempts to block spam have the unintended consequence of increasing the amount of electronic mail traffic. Spammers, knowing mail gets blocked, will send multiple copies of messages with header and content variations in the expectation that one or more of the messages will get through to the intended recipient mailbox. They will also redundantly send messages from different servers. Accordingly the current art is inefficient in the task of blocking spam mail messages and not only does little to reduce the amount of spam traffic but, unfortunately promotes an increase in the traffic, degrading the networks providing mail services.

Definitions

Mail: Any electronically, optically, electro-magnetically, or the like transmission over a network of a message intended for use by a human recipient.

SMTP: Simple Mail Transaction Protocol, SMTP protocols are defined in RFCs of Internet Engineering Task Force, Internet Mail Consortium

Keywords: SMTP service extensions

UA: User Agent, A User Interface for generating and reading mail messages

MTA: Message Transfer Agent, A mail application embodied on a computing device comprising at least one of outgoing and incoming mail functions

OMTA: Outgoing Message Transfer Agent, The functional portion of an MTA that sends mail.

IMTA: Incoming Message Transfer Agent, The functional portion of an MTA that receives mail.

Mailbox: The location where an IMTA delivers messages to an intended recipient. The mailbox may comprise a memory location, a printer, a voice mailbox, or combinations thereof and the like.

Mail Transaction: The process of negotiating the sending of a batch of one or more messages to one or more recipients at the same MTA.

Message Transaction: The process of negotiating the sending of a message to a specified recipient.

Conventions

Angle brackets (<>) are used to denote the value of the element named within the angle brackets.

The SMTP convention is used herein as illustrative of an e-mail transaction. The inventor does not intend to limit the scope of the invention to only SMTP transactions where other electronic mail protocols may make use of the same invention. To this end, a general electronic mail transaction will be referred to as “mail” and an SMTP specific transaction will be referred to as “SMTP mail”.

Cryptography

Cryptographic systems, including ones implementing public key cryptography, are described in the technical, trade, and patent literature. For a general description, see for instance, Schneier, Bruce, Applied Cryptography, Second Edition, John Wiley & Sons, Inc., 1996. For a description focusing on the PGP.™. implementation of public key cryptography, see for instance, Garfinkel, Simon, PGP: Pretty Good Privacy, O'Reilly & Associates, Inc., 1995. The disclosures of each of the foregoing are hereby incorporated by reference.

Cryptographic methods for protecting software applications are described in the paper, White-Box Cryptography and an AES Implementation, from Cloakware at http://206.191.60.52. The paper is available in PDF format.

### SUMMARY OF INVENTION

MTAs (Message Transfer Agents) are software applications embodied on pluralities of computing devices in a network for the purpose of transferring electronic mail messages from one location to another. For illustration purposes, the MTAs described herein communicate via electronic means over the Internet, LAN (Local Area Network), WAN (Wide Area Network), or the like using a connection interface which establishes an initial communication protocol and buffers and routes incoming and outgoing signals. MTAs embodied on different computing devices may not be identical; however, they perform similar functions.

Typically in an SMTP (Simple Message Transfer Protocol) mail process, an electronic mail object is created on a UA (User Agent) GUI (Graphic User Interface) software application in response to input from a person originating the message. The mail object comprises an envelope and the message. The envelope comprises an originator address and one or more recipient addresses. The message comprises headers in the form of field name/value pairs and a message body. The mail object is submitted by the UA to an outgoing mail server, known as an MTA (Message Transfer Agent), in response to a send command from the originating person. The outgoing MTA examines the mail object for recipient information and establishes a two-way communication channel with the MTA of the intended recipient.

FIG. 1 is exemplary of a mail transaction sequence of communication steps in a successful message transfer process, consistent with SMTP standards RFC2821. The use of the terms OMTA (Outgoing Message Transfer Agent) and IMTA (Incoming Message Transfer Agent) here represent functional distinctions used to identify the operations of the outgoing, MTA-1, and incoming MTA-2, agents. Typically, in SMTP mail and other mail applications, the mail server comprises both OMTA and IMTA functions in a single software application embodied on a computing device. The combined functions comprise an MTA (Message Transfer Agent). The sequence and description of steps is:

Step 1. A communication channel between MTAs is opened, the OMTA sends the command, EHLO in compliance with RFC2821 followed by a space and the fully-qualified domain name of the OMTA. The EHLO command tells the IMTA that the OMTA can process SMTP service extensions and requests a list of extensions supported by the IMTA.

Step 2. The IMTA responds with “250” followed by a space, a domain identifier, a greeting, and on separate lines, a plurality of keywords used to identify supported SMTP service extensions.

Step 3. The OMTA initiates a mail transaction with a one line command, “MAIL FROM:<reverse path>”. The reverse path is typically the sender's e-mail address as provided in the envelope.

Step 4 The IMTA responds with “250” to indicate that it is ready to communicate with the OMTA.

Step 5. The OMTA sends “RCPT TO:<forward path>”. The forward path is typically the e-mail address of the recipient as provided in the envelope.

Step 6. The IMTA responds with “250” to indicate that it has received the recipient information. It stores the forward path information.

Step 7. The OMTA sends the command, “DATA”.

Step 8. The IMTA responds with an interim reply, “354” to indicate that it is ready to receive data.

Step 9. The OMTA sends the message and on a separate line a period (.) to indicate the end of the data transmission.

Step 10. The IMTA responds with “250” to indicate successful receipt of data and stores the message.

Step 11. The OMTA sends a “QUIT” command.

Step 12. The IMTA responds with “250” and closes its connection.

Step 13. The OMTA closes its connection upon receipt of the “250” response.

This process, in itself, does not provide any direct method of determining the acceptability of a mail transaction other than verifying that a valid recipient mailbox does reside with the IMTA. Accordingly, it is the object of this invention, to provide an improved method and means for governing the sending and delivery of electronic mail messages by incorporating a data token of monetary value in an electronic mail transaction. The token comprises a syntactically arranged set of data elements. A token, comprising a number of credits, is sent to an IMTA from an OMTA as part of a mail transaction. The data elements of an incoming token are processed at the IMTA to evaluate and authenticate the token and apply rules of mail delivery that may allow or disallow the delivery of a mail message to the intended recipient's mailbox. Delivery of messages causes to be applied to an IMTA account, the credits comprising the token with an equal number of token credits deducted from the OMTA account. The monetary value of the token is related to the number of credits imbedded in the token. Therefore, it is-a further object of the invention to demonstrate a method and means for issuing and redeeming token credits for MTAs and for establishing the monetary value of a credit and there-by, the monetary value of the token. The token will here-in-after be referred to as an eMstamp (Electronic Mail Stamp pronounced em-stamp).

An eMstamp derives monetary value by imbedding credits purchased from an issuing,agency. Upon being paid for a given number of eMstamp credits by the administrator of an MTA, the issuing agency electronically communicates via the Internet or the like with the MTA application. The issuing agency increments an eMstamp bank memory count of that MTA by an amount numerically equivalent to the number of eMstamp credits purchased. This is a process similar to “charging” an ordinary postal service stamp machine. Each time an outgoing message is sent, the MTA generates an eMstamp and increments the count of an outgoing memory count by the number of credits imbedded in the outgoing eMstamp. This is a process similar to depleting an ordinary postal service stamp machine. Each time an incoming message with a validated eMstamp is received by an MTA, the count of a received memory count is incremented by the number of credits imbedded in the eMstamp. Administrators of MTAs can contact the issuing agency for redemption of eMstamp credits when the received count plus the bank count exceeds the sent count. The issuing agency electronically communicates via the Internet or the like to the relevant MTA, reduces the number of the bank count by the number of credits being redeemed and pays the administrator an amount equivalent to the number of credits redeemed times a set value related to the purchase cost of an eMstamp credit.

It is a further object of the invention to demonstrate a method and means for establishing recipient mailbox privacy levels by using a numerical value associated with a mailbox in a rule for determining the number of eMstamp credits required of an incoming mail transaction before message delivery is accepted. Setting high privacy numbers for mailboxes will impose on the outgoing MTA a requirement for an equivalent or greater number of eMstamp credits to cause delivery of a message and consequently a higher cost of sending a message to that particular mailbox.

Privacy rules not withstanding, this invention provides a method and means where-by mail transactions are governed in a manner that is transparent to the end user, avoiding the need for every day users of electronic mail to learn new techniques. The intended consequence of the invention is to reduce the overall volume of electronic mail currently saturating networks and to discourage the indiscriminate dissemination of unsolicited bulk mail by imposing charges on administrators of MTAs that send more mail than received. Distribution and use of the invention is encouraged by transferring a portion of eMstamp credit charges to administrators of MTAs that receive more mail than is sent. It is yet a further object of the invention to prevent the spread of self-replicating e-mail viruses by refusing mail transactions at incoming MTAs where there is no eMstamp incorporated with the transaction.

Typically in a trusted environment where fees are imposed, it can be expected that attempts will be made by certain MTA administrators or their agents to subvert the intended purpose of the current invention by altering the software embodiment enabling eMstamp mail transactions. Therefore, in an alternate embodiment of the current invention, security layers, protecting an eMstamp transaction and preventing unauthorized manipulation of eMstamp software and credits are described.

These and other advantages and features of the present invention will become readily apparent to those skilled in the art of electronic mail systems and software after reading the following detailed description of the invention and studying the accompanying drawings.

### BRIEF DESCRIPTION OF DRAWINGS

FIG. 1. A basic SMTP message transfer process.

FIG. 2A A block diagram of eMstamp elements

FIG. 2B. Illustration of a possible eMstamp string using programming tokens

FIG. 3. A block diagram of two MTAs from a network of MTAs with sender UA rules and mailbox rules

FIG. 4. A flow chart showing basic steps in the process of sending and receiving mail using an eMstamp

FIG. 5. Block diagram of the main elements in an eMstamp enabled system

FIG. 6. A basic SMTP message transfer process using an eMstamp.

FIG. 7A. A block diagram of program functions comprising the incoming module of an eMstamp enabled MTA.

FIG. 7B. A flow chart of the operation of the incoming eMstamp module

FIG. 8A. A block diagram of program functions comprising the outgoing module of an eMstamp enabled MTA.

FIG. 8B. A flow chart of the operation of the outgoing eMstamp module

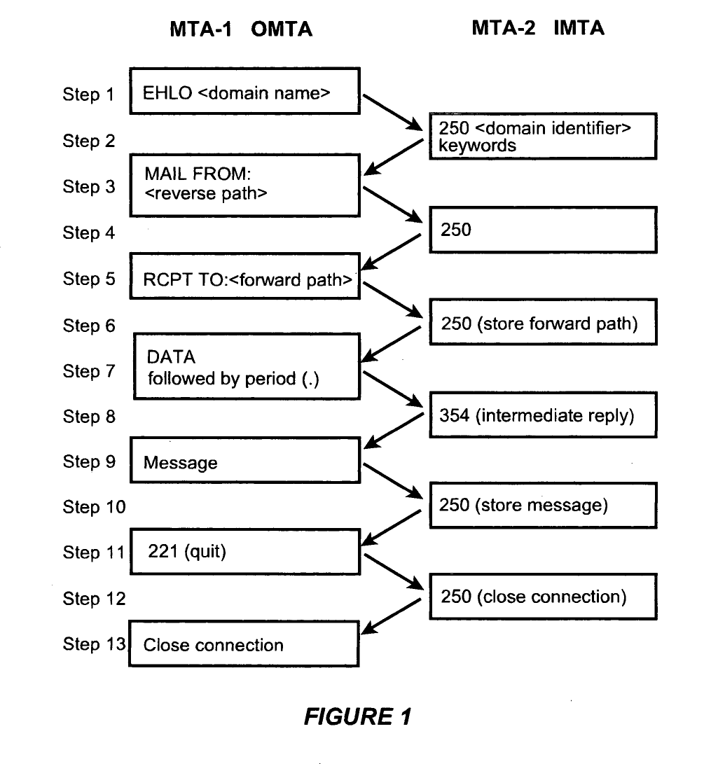

### DETAILED DESCRIPTION OF THE INVENTION

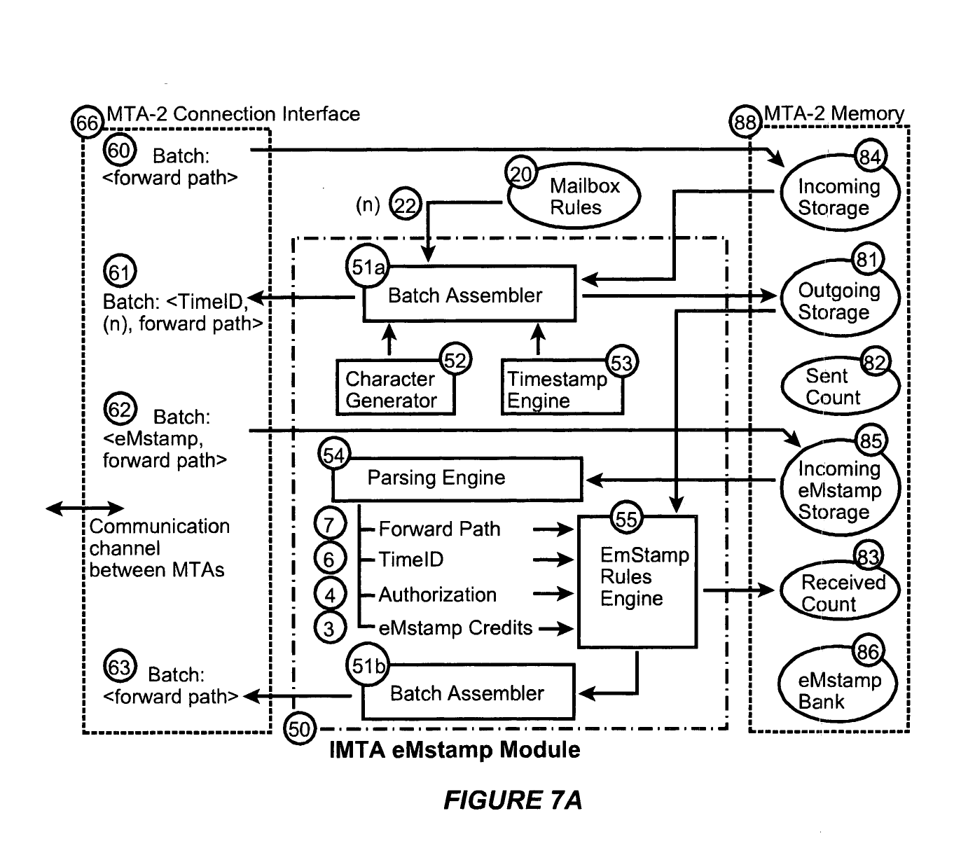

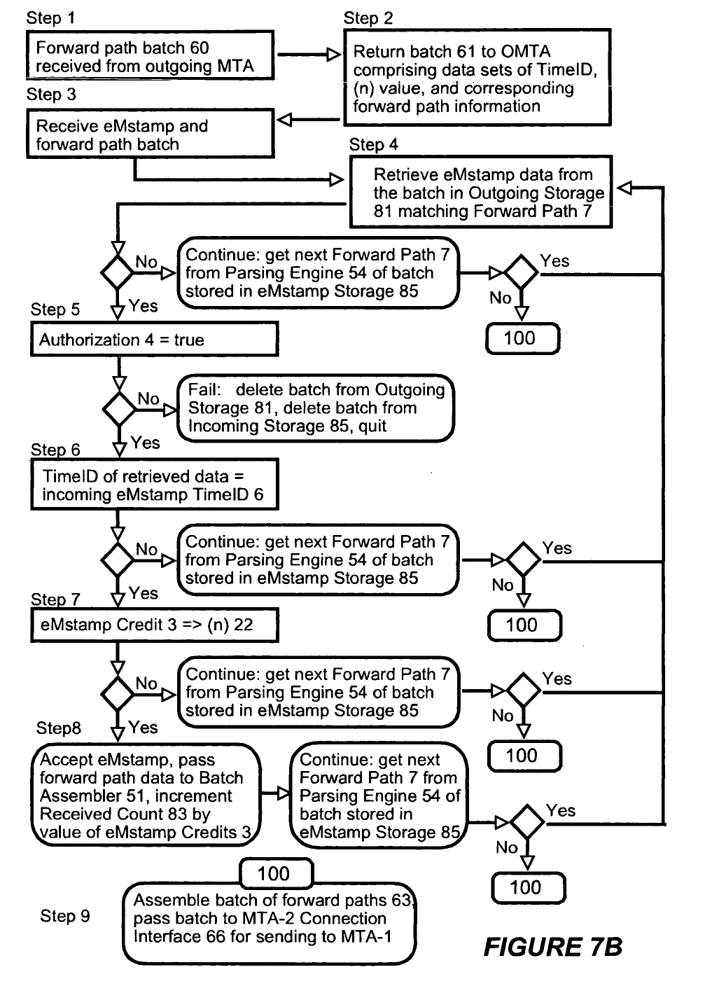

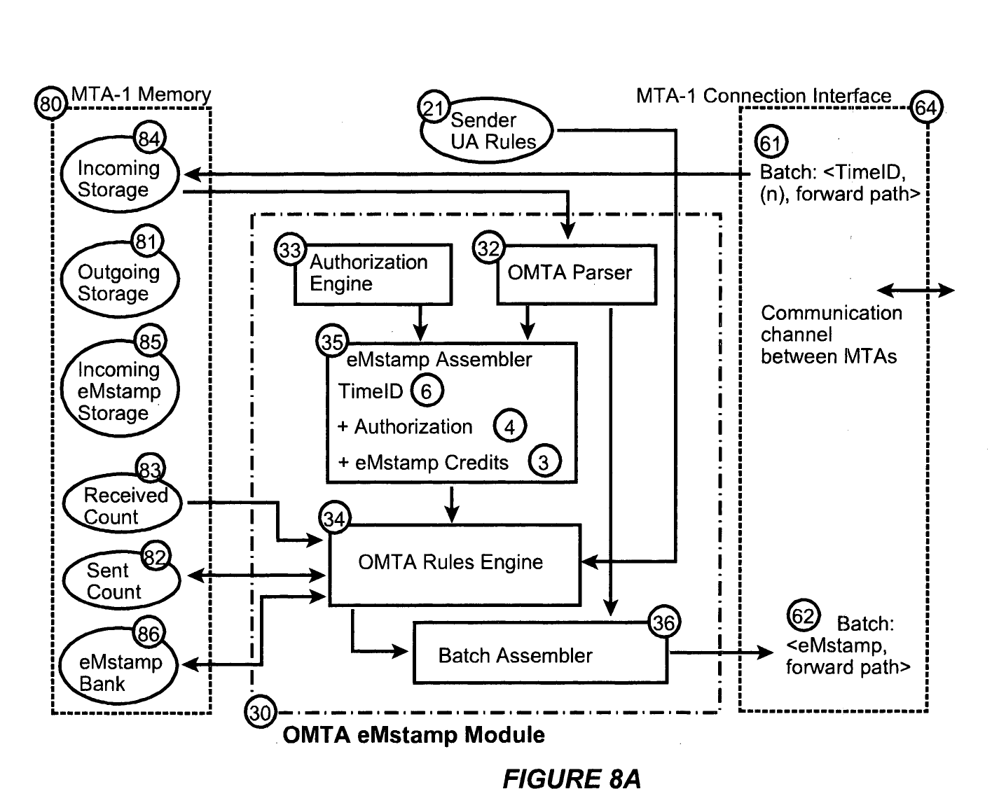

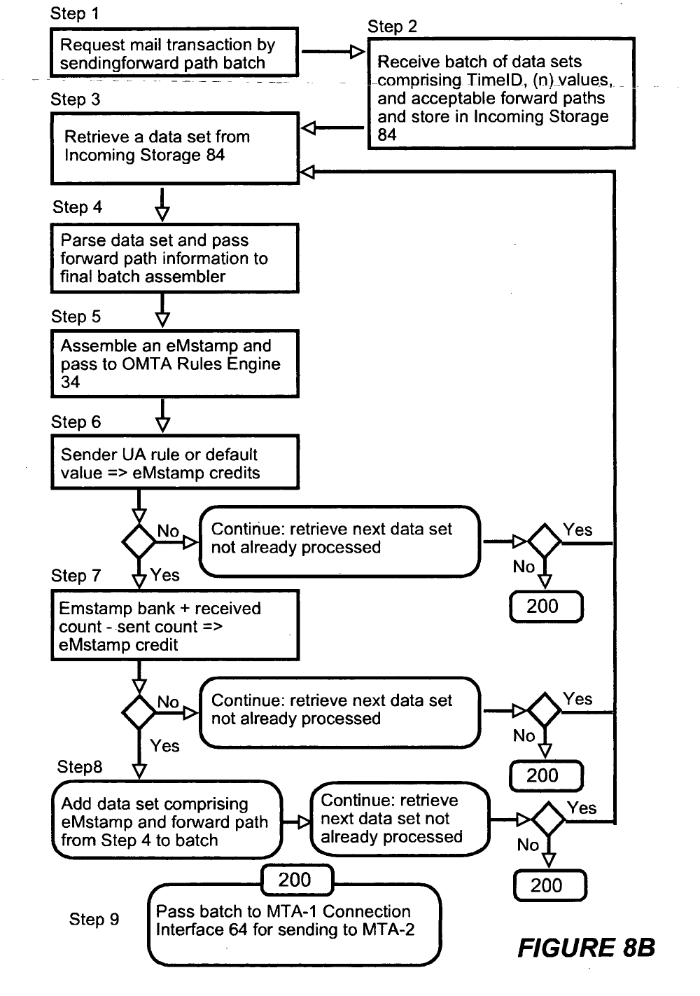

MTAs embodied on different computing devices may not be identical; however, for purposes of illustration, MTAs 1 and 2 of FIGS. 7A and 8A are shown as having the same memory storage operations as exemplified by using the same numbers to identify each operation. FIGS. 7A and 8A focus on the operations pertinent to the software functions, comprising the eMstamp utility of an MTA.

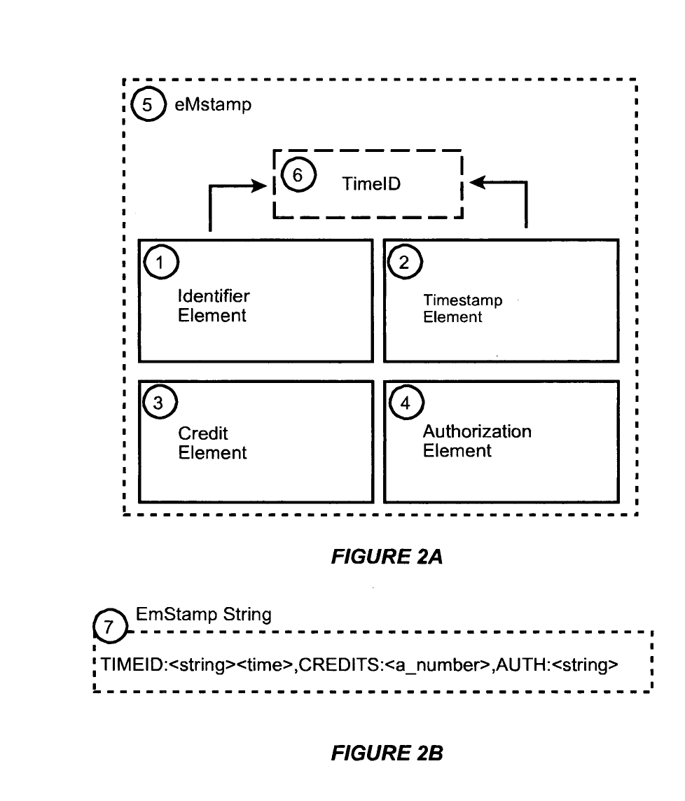

FIG. 2A is a block diagram of eMstamp elements. The eMstamp is a data token comprised of data elements assembled into a syntactically consistent string. Each data element has a specific value serving a specific purpose and conforming to specific rules of syntax. For illustrative purposes the data elements are shown separately. However, two or more elements may be combined to make one element serving multiple purposes. Identifier Element 1 is a finite length string of randomly generated allowed characters. Timestamp Element 2 is a series of numbers representing the time in milliseconds from 1970 or the like. Credit Element 3 is a number representing multiples of eMstamp credits and is used to reflect monetary value for the eMstamp. Authorization Element 4 comprises data used to authenticate eMstamp enabled MTAs. Referring here to Identifier Element 1 and Timestamp Element 2 of FIG. 2A, these two elements in practice, may be combined into a single identifier element by appending Timestamp Element 2 to a plurality of randomly generated characters of Identifier Element 1 into a single element having both identification and timestamp information. This possible combination is illustrated in FIG. 2A as TimeID 6. The two essential data elements needed to constitute an eMstamp data token are an identifier element and a number of credits which can include the zero value. An eMstamp data token may have fewer or more data elements as required specific to a mail transaction and two or more elements may be combined to form one element as long as essential information is not lost.

FIG. 2B illustrates an example of an eMstamp String 7 using programming tokens in a comma-delimited string. There is no a-priori reason for constructing the eMstamp with this syntactical format since there are currently no engineering standards governing the generation of eMstamps and there is no standard for parsing an eMstamp for the purpose of retrieving the value of the data elements. However this format is suggested to illustrate one possible syntactical construct using name/value pairs to allow parsing without prior knowledge of the sequence of data elements. In this example, three fields are employed; although, it will be appreciated that additional fields with other information, or fewer fields, may also be employed.

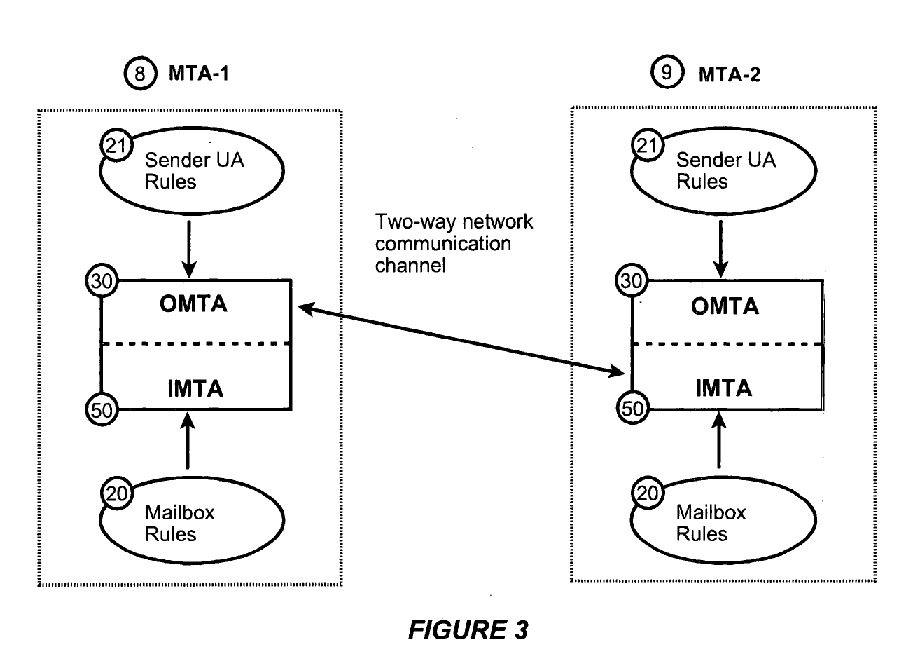

FIG. 3 illustrates two MTAs in a network of MTAs, having established a two-way communication channel each to the other over the Internet or the like for the purpose of conducting a mail transaction. MTA-1 8 is serving as the outgoing message transfer agent, OMTA 30. MTA-2 9 is serving as the incoming message transfer agent, IMTA 50. An OMTA initiates a mail transaction with an IMTA of the intended recipient using a SMTP or a like protocol. It is understood that MTAs often, but not necessarily, support both incoming and outgoing mail transactions. In a preferred embodiment of the invention, MTAs support the ability to-read-rules associated-with the mail client of the person originating a message, the UA (User Agent), and rules associated with the mailbox of the intended recipient of a message. These rules are illustrated herein as Mailbox Rules 20 established by an intended recipient and Sender UA Rules 21 established by a message sender. The rules can be used independently or in concert to govern the deliverability of mail messages. It is understood that where a specific rule does not exist for a particular mail transaction, the administrators of MTAs can establish policy for substituting default values or, in the case of inappropriate rule values, override the values. In one embodiment of the invention, a rule is established by Sender UA Rules 21 governing the maximum number of credits that can be allowed for a message transaction to a specified intended recipient. In a corresponding rule, an intended recipient can establish a Mailbox Rule 20 governing the minimum number of credits required of a sender before allowing delivery to the mailbox. This Mailbox Rule 20 is called a privacy level rule. In the first instance, MTA-1 8 requests a message transaction with MTA-2 9 by sending a mail command with forward path information. The forward path information identifies the intended recipient mailbox. In the second instance, MTA-2 9 responds with information comprising the requested forward path and a privacy value derived from Mailbox Rule 20 representing a number of credits required to allow delivery to the intended recipient mailbox. In the third instance, MTA-1 8 insures that the received privacy rule value does not exceed the maximum number of credits allowed by Sender UA Rules 21 for sending mail to the intended recipient. MTA-1 8 may also apply rules governing the maximum number of credits that can accompany any mail transaction. MTA-1 8 then continues or quits the message transaction according to an application of the credit rules. In one preferred embodiment of the invention the credits referred to herein are eMstamp Credits 3 of FIG. 2A.

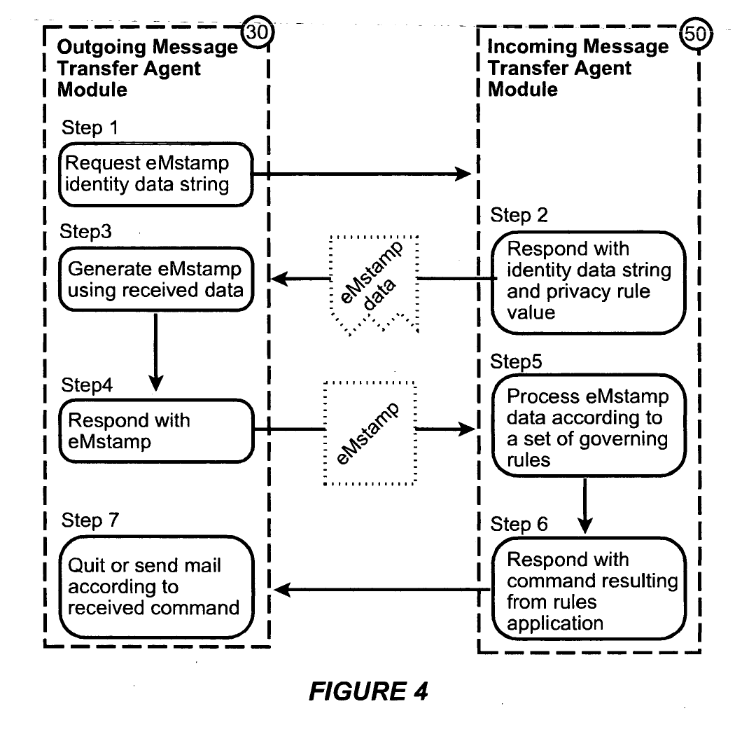

FIG. 4 illustrates the flow of information for a basic eMstamp transaction between MTAs during an electronic mail transaction. In the first instance, Step 1, the Outgoing Message Transfer agent Module 30 of an originating MTA sends information comprising. a request for an eMstamp identity data string from the MTA serving the intended recipient of a mail message. In the second instance, Step 2, the Incoming Message Transfer agent Module 50 of the receiving MTA responds with information comprising an eMstamp identity data string and a privacy rule number. The eMstamp identity may be the TimeID 6 illustrated in FIG. 2A. The privacy rule number is a default value or the value set in a privacy rule governing the number of eMstamp credits required to deliver a message to the mailbox of the intended recipient. In Step 3, the Outgoing Message Transfer agent Module 30 generates an eMstamp by combining the received eMstamp identity data, an authorization code derived from a confirmation of the authenticity of Outgoing Message Transfer agent Module 30 described as Authorization Element 4 of FIG. 2A, and a default number or the privacy rule number received from Outgoing Message Transfer Module 50 described as eMstamp Credit Element 3 of FIG. 2A. Information comprising the complete eMstamp is returned to the Outgoing Message Transfer agent Module 50, Step 4 where it is processed according to governing rules, determining the correctness of all eMstamp elements in relation to any other information received, Step 5. In Step 6, based on the outcome of the processing in Step 5, the Incoming Message Transfer Agent Module 50 returns a command to the Outgoing Message Transfer Agent Module 30 to either continue or quit the transaction. The Outgoing Message Transfer Agent Module 30 either continues or quits the transaction, Step 7.

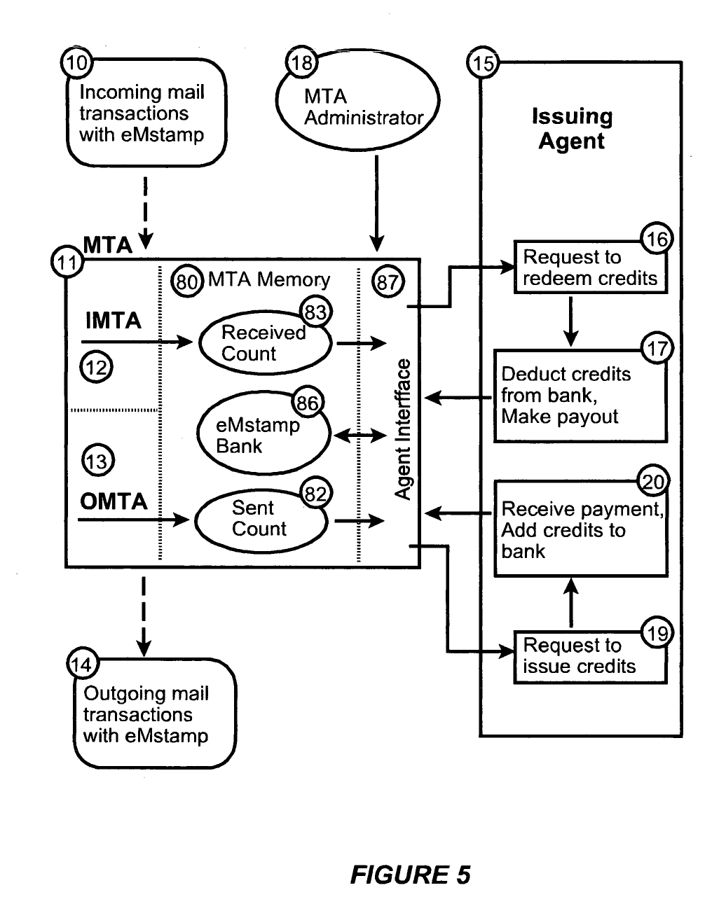

FIG. 5 illustrates the main functional elements comprising an eMstamp enabled system for sending and receiving electronic mail. MTA 11 is an eMstamp enabled message transfer agent connected via the Internet or the like to other message transfer agents. Incoming Mail 10, having an eMstamp, is received by the IMTA 12 function of an eMstamp enabled MTA 11. Upon validation of the received eMstamp and deemed deliverability to the intended recipient mailbox, IMTA 12 causes the eMstamp Credits 3 of FIG. 2A to be added to the Received Count 83 of MTA 11 Memory 80. Outgoing Mail 14 comprising an eMstamp is sent by OMTA 13 function of eMstamp enabled MTA 11. Upon sending, OMTA 13 causes to be added to Sent Count 82 of MTA 11 Memory 80 the number of eMstamp Credits 3 of FIG. 2A, comprising the sent eMstamp. The OMTA of an eMstamp enabled MTA cannot send mail unless Received Count 83 plus credits in eMstamp Bank 86 exceeds Sent Count 82 by an amount equal to or greater than the number of credits comprising a sent eMstamp. MTA Administrator 18 can read MTA 11 Memory 80 via Agent Interface 87 to determine if the total of Received Count 83 plus the eMstamp Bank 86 credits is sufficient for the MTA 11 to continue eMstamp mail sending operations. If the count is not sufficient, MTA Administrator 18 can contact Issuing Agent 15, over the Internet or the like, via Agent Interface 87, with a Request to issue Credits 19. Upon receipt of payment for a requested number of credits, Issuing Agent 15 connects via the Internet of the like with MTA 11 via Agent Interface 87 to Add credits to bank 20. Agent Interface 87 supports secure communication protocols and read/write access to MTA 11 memory along with general access to elements of the MTA as might be required by the Issuing Agent. Issuing Agent 15 causes to be added to eMstamp Bank 86 memory a credit count equivalent the number of credits purchased. Similarly, eMstamp credits can be redeemed. MTA Administrator 18 can contact Issuing Agent 15 via Agent Interface 87 with a Request to redeem credits 16. Issuing Agent 15 connects to MTA 11 via Agent Interface 87 and confirms that Received Count 83 plus the count in eMstamp Bank 86 equals or exceeds Sent Count 82 by the requested redemption number. Issuing Agent 15 then causes to be subtracted from eMstamp Bank 86 a count equivalent to the number of credits being redeemed. Issuing Agent 15 then pays MTA Administrator 18 for the redeemed credits.

It is understood that MTA Administrator 18 may be a person that reads MTA 11 Memory 80 values from the administered MTA to determine when to purchase or redeem eMstamp credits or MTA Administrator 18 may be a software application running on the MTA that automatically connects to Issuing Agent 15 based on MTA count value rules. In the case of an automatic administrator application, payments for purchased or redeemed eMstamp credits would be made to or from pre arranged currency accounts.

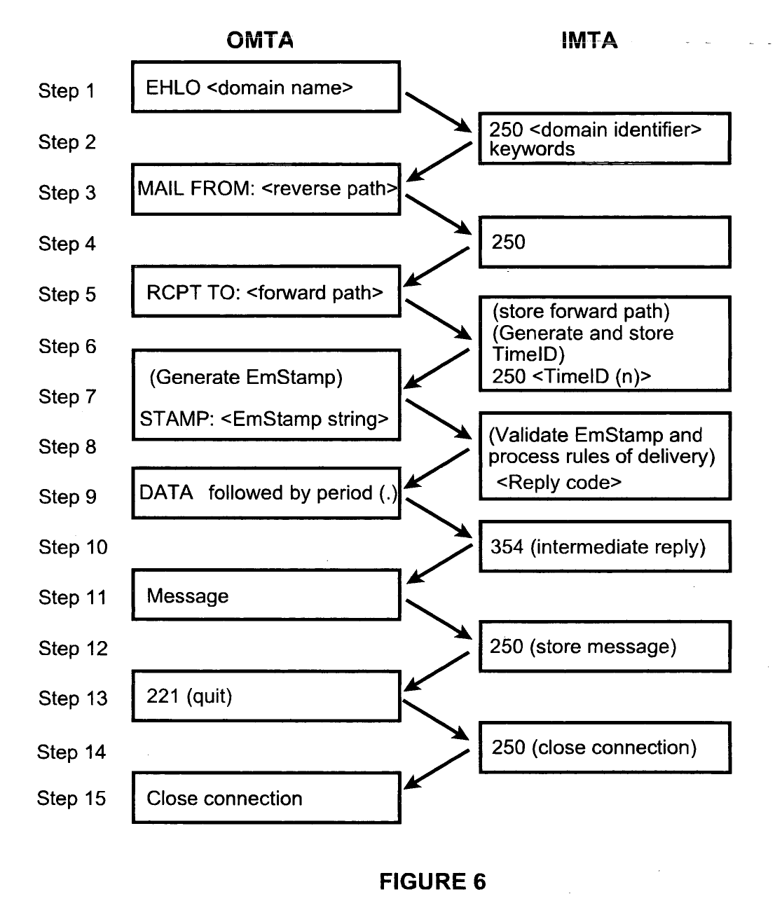

FIG. 6 is exemplary of communication steps in a successful message transfer process using an eMstamp in a process consistent with SMTP standards. This invention is not predisposed toward interjecting eMstamp communications in the sequence at any specific step but, rather toward insuring that the eMstamp is passed and acted upon at some point in the mail transaction or during a subsequent transaction related to the initial transaction. For instance, the eMstamp could be sent after Step 6 and acted upon during a current SMTP transaction or sent in Step 9 as a component comprising the header of a message and acted upon in a subsequent transaction. To that end, the steps of FIG. 6 are exemplary of an eMstamp transaction as it might take place in an SMTP transaction. For clarity, a single recipient is indicated. It is understood that in certain mail transactions, a batch of forward path information may be sent by an OMTA. Subsequent descriptions of software embodiments will show provisions for batch processing multiple recipients. The sequence and description of steps follows:

Step 1. Upon establishing a communication channel, the OMTA sends the command, EHLO in compliance with RFC2821 followed by a space and the fully-qualified domain name of the OMTA. The EHLO command tells the IMTA that the OMTA can process SMTP service extensions and requests a list of extensions supported by the IMTA.

Step 2. The IMTA responds with “250” followed by a space, a domain identifier, a greeting, and on separate lines, a plurality of keywords used to identify supported SMTP service extensions.

Step 3. The OMTA initiates a mail transaction with a one line command, “MAIL FROM:<reverse path>”. The reverse path is typically the sender's e-mail address as provided in the envelope.

Step 4. The IMTA responds with “250” to indicate that it is ready to communicate with the OMTA.

Step 5. The OMTA sends “RCPT TO:<forward path>”. The forward path is typically the e-mail address of the recipient as provided in the envelope.

Step 6. The IMTA responds with “250” to indicate that it has received the intended recipient (forward path) information. It stores the forward path and appends TimeID 6 of FIG. 2A and optionally a number, n 22 as illustrated in FIG. 5, representing a delivery rule of the intended recipients mailbox, to the 250 reply.

Step 7. The OMTA assembles the eMstamp data and returns the command, STAMP:<stamp-data>. Stamp-data is a concatenated string of information making up an eMstamp.

Step 8. The IMTA checks the eMstamp for validity and monetary value expressed in units and applies a rule set of the IMTA and optionally the recipient mailbox to accept or reject the eMstamp. Upon acceptance the IMTA returns a “250” reply.

Step 9. The OMTA sends the command, “DATA”.

Step 10. The IMTA responds with an interim reply, “354” to indicate that it is ready to receive data.

Step 11. The OMTA sends the message and on a separate line a period (.) to indicate the end of the data transmission.

Step 12. The IMTA responds with “250” to indicate successful receipt of data and stores the message.

Step 13. The OMTA sends a “QUIT” command.

Step 14. The IMTA responds with “250” and closes its connection.

Step 15. The OMTA closes its connection upon receipt of the “250” response.

FIG. 7A, IMTA eMstamp Module 50, is exemplary of an architecture for the block of-application software functions serving emstamp operations relating to the incoming mail operations of an MTA. In the first instance, as exemplified by SMTP transaction, Step 5 of FIG. 6, incoming data from an outgoing eMstamp MTA, FIG. 6, MTA-1, is received at MTA-2 Connection Interface 66. Data comprising Batch:<forward path> 60, identifying intended recipients, is caused to be stored by MTA-2 Connection Interface 66 in Incoming Storage 84 of MTA-2 Memory 80, and causes the activation of Batch Assembler 51a. Batch Assembler 51a and 51b is a software means for assembling strings of information into a computer readable format, typically one string of data per line. Batch Assembler 51 assembles a TimeID comprised of Character Generator 52 output and Timestamp Engine 53 output in accordance with the elements for an eMstamp described and illustrated as FIG. 2A. For each forward path received, Batch Assembler 51 assembles a TimeID, a numerical value (n) 22 derived from the intended recipient's Mailbox Rules 20 governing the mailbox privacy level, and the forward path of the intended recipient in a string format such that each value can be easily identified for parsing on MTA-1. If (n) 22 is null or otherwise unavailable, Batch Assembler 51 sets the value of (n) to 1. Batch Assembler 51 loops through the assembly process, creating a data set of TimeID, (n) values, and forward paths for each of the intended recipients into a batch and passes the assembled batch 61 to MTA-2 Connection Interface 66 for sending to MTA-1. A batch may comprise just one data set of intended recipient values. Batch Assembler 51 also causes to be stored in Outgoing Storage 81 the assembled batch. Forward paths unacceptable to IMTA-2 may be dealt with in the batch by substituting an error code in place of the TIMEID in the string containing that forward path or by negotiating with MTA-1 over each individual forward path. For purposes of discussion, Batch Assembler 51, verifies the forward path and substitutes the error code for unacceptable forward paths. Incoming Storage 84, Incoming eMstamp Storage 85, Sent Count 82, Received Count 83, and eMstamp Bank 86 are memory functions to indicate, in terms of the purpose served, computer memory available to MTA operations and may be hard disk, floppy disk, volatile memory, or any other storage media. These constructs are illustrated as belonging to MTA-1 Memory 80 and MTA-2 Memory 88.

In the second instance, MTA-1 returns a batch of eMstamps 62, assembled with their corresponding forward paths. MTA-2 Connection Interface causes to be stored the returned batch in Incoming eMstamp Storage 85. Receipt and storage activates eMstamp Parsing Engine 54 to retrieve and parse one eMstamp data set at a time from Incoming eMstamp Storage 85 and provide the forward path and parsed eMstamp data to eMstamp Rules Engine 55. eMstamp Rules Engine 55 then retrieves a matching Forward Path 7 set of data from Outgoing Storage 81. eMstamp Rules Engine 55 then compares TimeID 6 of the parsed eMstamp retrieved from Incoming eMstamp Storage 85 with the TimeID value of the retrieved data set from Outgoing Storage 81 for an exact match. An exact match is required to validate an incoming eMstamp. eMstamp Rules Engine 55 then applies a rule to the parsed Authorization 4 value to determine if the eMstamp has originated from an MTA running authorized eMstamp software. In the basic embodiment described here, without security layers, Authorization 4 has a value representing “true”. eMstamp Rules Engine 55 then compares the parsed eMstamp Credits 3 value with the number (n) 22 of the retrieved data set from Outgoing Storage 81 to determine deliverability of the mail message to the intended recipient's mailbox. The default governing rule is to deliver the mail if the eMstamp Credits 3 value equals or exceeds the value of (n) 22. A positive validation, authorization, and number of credits constitute an authenticated eMstamp. eMstamp Rules Engine 55 then causes to be added to Received Count 83 the value of eMstamp Credits 3 from an authenticated eMstamp and passes each authenticated eMstamp forward path to batch assembler 51b. Upon completion of the loop on a batch, Rules Engine 55 causes Batch Assembler 51 to pass the batch of forward paths 63 to MTA-2 Connection Interface 81 for sending to MTA-1.

FIG. 7B is a flow chart illustrating the sequence of steps in the operation of IMTA eMstamp Module 50.

Step 1. A batch comprising forward path information 60 is received from the outgoing MTA, MTA-1, by MTA-2 Connection Interface 66 and caused to be stored in Incoming Storage 84. This is the equivalent of Step 5 of FIG. 6, typifying an SMTP mail transaction.

Step 2. Batch Assembler 51a returns to the outgoing MTA an assembled batch of data sets 61 for each forward path stored in Incoming Storage 84, comprising a TimeID assembled from Character Generator 52 and Timestamp Engine 53, an (n) 22 value derived from Mailbox Rules 20, and the related forward path from Incoming Storage 84. Batch assembler 51a also causes to be stored the assembled batch information in Outgoing Storage 81. Where an invalid forward path is encountered, Batch Assembler 51a substitutes an error code in place of the TimeID for the related forward path.

Step 3. A batch of data sets 62, comprising an eMstamp and the related forward path information is received back from the outgoing MTA, MTA-1 and stored in Incoming eMstamp Storage 85.

Step 4. Retrieve eMstamp data and the (n) value from Outgoing Storage 81, using the parsed Forward Path 7 information to identify the data. If no relevant data is found, the next data set in the batch is parsed and Step 1 repeated for each data set in the batch until a matching data set is found or there are no new data sets to parse. If there is no next Forward Path 7, proceed to Step 9. If a forward path matching data set is found, Rules Engine 55 proceeds to Step 5.

Step 5. Require an Authorization 4 value of “true”. If Authorization 4 value is not “true”, Rules Engine 55 causes MTA-2 to reply to MTA-1 with a quit message rejecting further transactions and causes the deletion of batches in Outgoing Storage 81 and Incoming eMstamp Storage 85.

Step 6. Compare the retrieved TimeID to the parsed TimeID 6 for an exact match. If there is no exact match, Step 4 is repeated with the next Forward Path 7. If there is no next Forward Path 7, proceed to Step 9. If there is an exact match, Rules Engine 55 proceeds to Step 7.

Step 7. Compare the retrieved value of (n) 22 to the parsed eMstamp Credits 3. If the parsed credit value does not equal or exceed the value of (n) 22, Step 4 is repeated with the next Forward Path 7. If there is no next Forward Path 7, proceed to Step 9. If the parsed credit equals or exceeds the value of (n) 22, Rules Engine 55 proceeds to Step 8.

Step 8. Increment Received Count 83 by the value of eMstamp Credits 3, and continue to Step 4, getting next Forward Path 7 from Parsing Engine 54. If there is no next Forward Path 7, proceed to Step 9.

Step 9. Cause to be assembled forward paths into a batch in Batch Assembler 51 and passed to MTA-2 Connection Interface 66 for sending to MTA-1.

FIG. 8A, OMTA eMstamp Module 30, is exemplary of an architecture for the block of application software functions serving eMstamp operations relating to the outgoing mail operations of an MTA. In the second instance following a mail transaction request from the outgoing MTA by sending a batch of forward path information, as exemplified by SMTP transaction, Step 3 of FIG. 6, a batch 61 of data sets comprising TimeID, (n) value, and acceptable forward path information is received back at the outgoing MTA via MTA-1 Connection Interface 64 and caused to be stored in Incoming Storage 84. OMTA Parser 32 is activated to select one data set at a time from Incoming Storage 84, separating the forward path information from the TimeID and (n) value and passing the forward path information to by Batch Assembler 36. An eMstamp is assembled by eMstamp Assembler 35 from each data set using the TimeID 6 and the (n) value as eMstamp Credits 3 and Authorization 4 information from Authorization Engine 33. The assembled eMstamp is passed to OMTA Rules Engine 34. OMTA Rules Engine 34 compares the value of eMstamp Credits 3 to Sender UA Rules 21 to insure that the credits do not exceed the value allowed for an eMstamp mail to the intended recipient. If eMstamp rule of Sender UA Rules 21 is null or otherwise unavailable, a global default value assigned by the MTA administrator is applied. Rules Engine 34 next checks that the sum of credits available from eMstamp Bank 86 plus Received Count 83 minus Sent Count 82 equals or exceeds the value of eMstamp Credits 3. For each eMstamp that passes the Rules Engine 34 checks, the Sent Count 82 value is incremented by the value of eMstamp Credits 3 for that data set and the eMstamp is passed to Batch Assembler 36 for uniting with the forward path information received from OMTA Parser 32. Batch Assembler 36 is a software means for assembling strings of information into a computer readable batch format and causing the OMTA eMstamp Module 30 to loop through all data sets in Incoming Storage 84. When all data sets have been processed, Batch Assembler 36 causes MTA-1 Connection Interface 64 to send the assembled batch 62 of data sets each comprising an eMstamp and related forward path information to MTA-2 for processing.

FIG. 8B is a flow chart illustrating the sequence of steps in the operation of OMTA eMstamp Module 30.

Step 1. Request a mail transaction by sending batched forward path information.

Step 2. A batch 61 of data sets comprising TimeID, (n) values, and forward path information is received back from the incoming MTA, MTA-2, by MTA-1 Connection Interface 64 in and caused to be stored in Incoming Storage 84. This is similar to Step 6, FIG. 4.

Step 3. Retrieve a data set from stored batch.

Step 4. Parse data set and pass forward path information to Batch Assembler 36 and the TimeID and (n) value to eMstamp assembler 35.

Step 5. Assemble TimeID and (n) value along with authorization information as an eMstamp and pass to OMTA Rules Engine 34.

Step 6. Compare the value of eMstamp Credits 3 to a Sender UA Rules 21 value governing eMstamp credits assignable to mail to an intended recipient. If the value is null or otherwise unavailable use the default value set by the MTA administrator. If the value of eMstamp credits exceeds the value according to Rules 21 governing eMstamp credits or alternately the default value set by the MTA administrator, discontinue processing of current data and retrieve the next data set.

Step 7. Compare the value of eMstamp Credits 3 to the total of eMstamp Bank 86 credits plus Received Count 83 minus Sent Count 82. If the value of eMstamp Credits 3 exceeds the total discontinue processing of current data and retrieve the next data set. If the value of eMstamp Credits 3 does not exceed the total, add the data set comprising the eMstamp and related forward path information to a batch for sending to MTA-2. Add eMstamp Credits 3 value to Sent Count 82 memory. Steps 3 through Steps 8 are repeated until all data sets in Incoming Storage 84 have been processed, whereupon the completed batch 62 is passed to MTA-1 Connection Interface 64 for sending to MTA-2

An alternate preferred embodiment of the current invention comprises methods for protecting an eMstamp transaction, the eMstamp bank of credits, sent and received credit counts, and the eMstamp enabling software itself from alteration and duplication.

Referring here to FIG. 7A, data returned to the OMTA comprises a TimeID 61 which is stored in Outgoing storage 81. From the perspective of the IMTA this data creates a short-term unique identifier when returned to the IMTA as part of an eMstamp transaction. Copies of this data from the OMTA are rendered useless by the action of the IMTA which deletes the sent information from Outgoing storage 81 once one instance of identical data is received back. There-by, eMstamp Rules Engine 55 causes to be rejected any further transactions using the identical data. In the same transaction eMstamp enabling software itself is authenticated by encrypting the Batch 61 data sent to an OMTA from an IMTA employing secret or public key encryption techniques know in the trade. Failure of an OMTA to properly decrypt the received data results in a “false” value being entered into the returned eMstamp Authorization Element 4 of FIG. 8A. There-by, eMstamp Rules Engine 55 of FIG. 7A causes to be rejected any further transactions with that particular MTA. In addition, the assembled eMstamp received in Batch 62 may be encrypted by the OMTA, and decrypted by the IMTA.

In the instance of encryption and decryption using a secret key, both the IMTA and OMTA must have the secret key which is imbedded in the MTA software itself. It is therefore essential to protect this secret key from disclosure to unauthorized parties. A technique known as white box cryptography is employed which prevents the reverse engineering of the software in order to learn the secret key. A document, White-Box Cryptography and an AES Implementation, describing white box cryptography is available in PDF format from Cloakware at http://206.191.60.52 and is included herein by reference. In the instance of encryption and decryption using public/private key pairs the IMTA must refer to a internal cache of known public keys using the identity of the OMTA to get the public key of the OMTA or alternately refer to an outside source for this information. Encrypted data returned to the OMTA is then decrypted at the OMTA using the private key of the OMTA. In this instance, failure of the OMTA to decrypt the data indicates that the OMTA is not the OMTA it identified itself as when initiating a mail transaction. This technique then provides the advantage of authenticating the sending MTA and again, if proper decryption fails, a “false” authentication results causing the rejection of any further transactions with the OMTA by the IMTA eMstamp Rules Engine 55 of FIG. 7A.

Referring to FIGS. 5, 7A, and 8A, Sent Count 82, Received Count 83, and eMstamp Bank 86 values are encrypted using secret keys, protecting these values from unauthorized alteration. The secret keys encrypting Sent Count 82 and Received Count 83 values are imbedded in the MTA software to allow access to these values for adding sent and received eMstamp credits. These keys are protected from reverse engineering disclosure using the white box cryptography referenced above and may be the same keys. eMstamp Bank 86 values are encrypted using the same or preferably a different secret key known to an issuing agent. This secret key must also be imbedded and protected in the MTA software to allow access to the eMstamp Bank 86 value by OMTA Rules Engine 34 of FIG. 8A. Referring here to FIG. 5, Issuing Agent 15 employes a Secure Socket Layer (SSL) protocol or the like to communicate with MTA 11 via Agent Interface 87 thereby-protecting any communications from unauthorized intercept. Issuing Agent 15, by employing the secret keys is then able to read Sent Count 82 and Received Count 83 values and alter the eMstamp Bank 86 value in accordance with the methods established for FIG. 5. It is understood that the issuing agent could use a master key to access these values and to perform any other operations on the MTA software and stored values as may be required from time to time.

It is understood that numerous techniques are available for protecting software and stored values. This invention is not predisposed to the use of any particular technique but cites the above use of encryption keys as exemplary of one method to prevent unauthorized tampering with eMstamp enabled software and the values stored within an MTA. It is also understood that an issuing agent may have access to OMTA and IMTA software modules for the purpose of altering secret keys as may be required from time to time to insure protection.

References

Standards for SMTP E-Mail objects are defined by RFCs 2821 and 2822 which are included here-in by reference.
RFC2822, P. Resnick (2001) Internet Message Format
http://www.ietf.org/rfc/rfc2822.txt
RFC2821, J. Klensin (2001) Simple Message Transfer Protocol
http://www.ieff.org/rfc/rfc2821.txt
Internet Engineering Task Force, Internet Mail Consortium
http://www.imc.org/rfcs.html
   Patents
Paul, U.S. Pat. No. 5,999,932, Dec. 7, 1999
Mccormick et al, U.S. Pat. No. 6,023,723, Feb. 8, 2000
Paul, U.S. Pat. No. 6,052,709, Apr. 18, 2000
Scopp et al, U.S. Pat. No. 6,256,739 Jul. 3, 2001

1. A data token comprising a plurality of data elements, one of said elements is a string of characters identifying said token; another of said data elements is a numerical value of credits reflecting a monetary value of said token.

2. The data token of claim 1 further comprising; a string of characters for authenticating message transfer agents producing said data token wherein two or more of said elements may be combined to form a single data element wherein the combined data element comprises the same information as each separate data element.

3. A method governing the sending and delivery of electronic mail comprising the step of:
a incorporating a data token in a mail message transaction wherein said data token has monetary value.

4. The method of claim 3 where a plurality of mail messages to a plurality of intended recipients, all of said intended recipient mailboxes residing with one message transfer agent, are processed as a batch wherein each said mail message for each said intended recipient is identified by forward path information associated with one of said data token for each said mail message.

5. The method of claim 3 further comprising the steps of:
a. request from a message transfer agent for an identity data string from a message transfer agent of an intended recipient of a mail message;
b. responding to said request with said identity data string;
c. applying said identity data string to a data token generated by said outgoing message transfer agent;
d. responding to said incoming message transfer agent of said intended recipient with said data token;
e. processing said data token at said incoming message transfer agent according to a rule set governing the acceptability of said data token information;
f. responding to said outgoing message transfer agent with a command governing the further disposition of said mail message transaction;
g. continuing or quitting said mail message transaction according to said command from said incoming message transfer agent.

6. The method of claim 5 wherein the first responding step further comprises the inclusion of a numerical value established as a privacy rule of said intended recipient mailbox or a default value.

7. The method of claim 5 wherein the first applying step further comprises applying said numerical value of said privacy rule or a default value to said data token as a numerical value of credits reflecting a monetary value of said data token.

8. The method of claim 5 wherein the first responding step further comprises encryption of said identifying data string and the first applying step further comprises decryption of said identifying data string.

9. The method of claim 9 wherein the first applying step further comprises applying a string of characters for authenticating message transfer agents producing said data token.

10. The method of claim 5 wherein the second responding step further comprises encryption of the said data token and the first processing step further comprises decryption of said data token.

11. A method establishing monetary value of a data token comprising the steps:
a. requesting to purchase a quantity of credits from an issuing agent by the administrator of a message transfer agent;
b. paying by said administrator of said message transfer agent an amount of monies to said issuing agent equivalent to a monetary value of a credit times said requested purchase quantity;
c. adding said purchase quantity of said credits by said issuing agent to a memory bank of credits of said message transfer agent;
d. applying a number of said credits based on said memory bank of credits to said data token and accounting for the number of said credits so applied.

12. The method of claim 11 further comprising a method for redeeming said credits comprising:
a. requesting by the administrator of a message transfer agent a redemption of a quantity of said credits by said issuing agent;
b. confirming by said issuing agent that the number of said credits in said memory bank of credits plus the number of credits received from incoming data tokens minus the number of credits applied to outgoing data tokens equals or exceeds the requested redemption quantity;
c. subtracting of said requested redemption quantity of said credits from said memory bank of credits of said message transfer agent by said issuing agent;
d. paying said administrator of said message transfer agent an amount of monies related to the quantity of said requested redemption quantity of said credits;

13. A system governing the delivery of electronic mail comprising a plurality of message transfer agents embodied each on computing devices connected one to another via the Internet or the like, wherein some of said agents are enabled to apply user agent rules for sending mail messages and some of said agents are enabled to apply mailbox rules for receiving mail messages.

14. The system of claim 13 wherein one of said user agent rules establishes a maximum number of credits that can be incorporated in a mail message transaction for an intended recipient.

15. The system of claim 13 wherein one of said mailbox rules is a privacy rule which establishes a minimum number of credits required for delivery of a mail message to a mailbox of an intended recipient.

16. The system of claim 13 wherein an incoming message transfer agent responds to a mail transaction request with information comprising the value of said privacy rule of an intended recipient mailbox with the intended recipient information or, in the case where no said privacy rule exists, said incoming message transfer agent responds with a default value established by the administrator of said incoming message transfer agent.

17. The system of claim 13 wherein an outgoing message transfer agent incorporates the received said privacy rule value as the numerical value of credits comprising a data token or, in the case where no said privacy value is received, a default value established by the administrator of said outgoing message transfer agent.

18. A system comprising an issuing agent and at least two of a plurality of message transfer agents connected one to the other via the Internet or the like wherein said issuing agent communicates with at least one of said message transfer agents via the Internet or the like to add or subtract credits to a bank of credits maintained in memory of said message transfer agent upon a request by the administrator of said message transfer agent for a purchase or redemption of said credits.

19. The system of claim 18 wherein said message transfer agent adds credits comprising incoming data tokens to a received count memory and adds credits comprising outgoing data tokens to a sent count memory.

20. The system of claim 18 wherein said issuing agent evaluates the number of said bank of credits plus the number of credits in said received count memory minus the number of credits in said sent count memory in response to requests from said administrators to redeem credits and subtracts the redeemed number of said credits from said bank of credits and pays said administrator an amount of monies related to the number of said credits redeemed.

21. The system of claim 18 wherein said communication with at least one of said message transfer agents via the Internet or the like is secure.

22. Claim 18 wherein the value of credits in said bank of credits is encrypted.

23. Claim 19 wherein the resultant quantities of said credits added to said received count memory and to said sent count memory are encrypted;

24. Claim 20 wherein said issuing agent has knowledge of keys for decrypting values retained in said bank of credits, said sent count memory, and said received count memory.

25. Application software embodied on a computing device serving as a message transfer agent comprising:
a. A means for requesting a data string from the electronic message transfer agent of an intended recipient for identifying a data token used in a subsequent outgoing mail message transaction;
b. A means for generating a number of credits comprising a data token, said credits reflecting a monetary value;
c. A means for generating a data string authenticating said application software of the message transfer agent;
d. A means for assembling the data of parts a, b, and c into data fields of a data token and making said data token a part of an outgoing electronic mail transaction;
e. A means for adding the number of said credits applied to said data token to a sent count memory.

26. The application software of claim 25 further comprising:
a. A means for generating an identifying data string in response to a mail transaction request from an outgoing message transfer agent;
b. A means for appending a default numerical value to said identifying data string or alternately a numerical value derived from the privacy level rule of the intended recipient mailbox;
c. A means for evaluating information of an incoming said data token and applying rules governing delivery of a mail message to the mailbox of said intended recipient;
d. A means for adding a numerical value comprising said incoming data token to a received count memory.

27. The application software of claim 25 further comprising a means for decrypting said identifying data string from the electronic message transfer agent of an intended recipient when said identifying data string is encrypted and a means for encrypting the results of adding said credits of said data token to said sent count memory and a means for encrypting said data token.

28. Claim 26 further comprising a means for encrypting said identifying data string in response to a mail transaction request from an outgoing message transfer agent and for encrypting the results of adding said numerical value to said received count memory and a means for decrypting said data token.

29. The application software of claim 25 further comprising a means for secure two-way communication via the Internet or the like with an issuing agent.

30. The application software of claim 25 having embedded within a means for protecting said software from tampering.
